(19) United States
(12) Patent Application Publication
(10) Pub. No.: US 2013/0315138 A1
(43) Pub. Date: Nov. 28, 2013

(54) CONFIGURABLE SERVICES IN INTERNET PROTOCOL (IP)-BASED MULTIMEDIA SUBSYSTEM (IMS)

(71) Applicants: Michael Bath, Berlin (DE); Jiri Kalvoda, Brno (CZ)

(72) Inventors: Michael Bath, Berlin (DE); Jiri Kalvoda, Brno (CZ)

(73) Assignee: Nokia Siemens Networks Oy, Espoo (FI)

(21) Appl. No.: 13/478,319

(22) Filed: May 23, 2012

(51) Int. Cl. H04W 4/00

(52) U.S. Cl. 370/328

(57) ABSTRACT

A method and apparatus for providing configurable services in an IMS based network based on standardized iFC is provided. The method includes creating, in an internet protocol multimedia subsystem (IMS) based network, at least one data structure that is assigned to at least one subscriber aspect. The method further includes storing the at least one data structure in a network node of the IMS based network, and using the at least one data structure as a condition for evaluating filter criteria.

### BACKGROUND

1. Field

Embodiments of the invention generally relate to wireless communications networks, including, but not limited to, Internet Protocol (IP) Multimedia Subsystem (IMS) based networks, such as Long Term Evolution (LTE)and LTE-Advanced (LTE-A).

2. Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN) no RNC exists and most of the RNC functionalities are contained in the eNodeB (enhanced Node B).

Long Term Evolution (LTE) or E-UTRAN refers to improvements of the UMTS through improved efficiency and services, lower costs, and use of new spectrum opportunities. In particular, LTE is a 3GPP standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE is also expected to improve spectral efficiency in 3G networks, allowing carriers to provide more data and voice services over a given bandwidth. Therefore, LTE is designed to fulfill future needs for high-speed data and media transport in addition to high-capacity voice support. Advantages of LTE are, for example, high throughput, low latency, FDD and TDD support in the same platform, an improved end-user experience, and a simple architecture resulting in low operating costs.

Further releases of 3GPP LTE (e.g., LTE Rel-10, LTE-Rel-11) are targeted towards future international mobile telecommunications advanced (IMT-A) systems, referred to herein for convenience simply as LTE-Advanced (LTE-A).

LTE-A is directed toward extending and optimizing the 3GPP LTE radio access technologies. A goal of LTE-A is to provide significantly enhanced services by means of higher data rates and lower latency with reduced cost. LTE-A will be a more optimized radio system fulfilling the international telecommunication union-radio (ITU-R) requirements for IMT-Advanced while keeping the backward compatibility.

The Internet Protocol (IP) Multimedia Subsystem (IMS) is a standardized Next Generation Networking architecture that provides mobile and fixed multimedia services. IMS uses a Voice-over-IP (VoIP) implementation based on a 3GPP standardized implementation of session initiation protocol (SIP), and runs over the standard Internet Protocol (IP). IMS uses open standard IP protocols, as defined by the internet engineering task force (IETF).

### SUMMARY

One embodiment is directed to a method of providing configurable services in an IMS based network based on standardized iFC is provided. The method includes creating, in an internet protocol multimedia subsystem (IMS) based network, at least one data structure that is assigned to at least one subscriber aspect. The method further includes storing the at least one data structure in a network node of the IMS based network, and using the at least one data structure as a condition for evaluating filter criteria.

Another embodiment includes an apparatus which may include at least one processor and at least one memory comprising computer program code. The at least one memory and the computer program code may be configured, with the at least one processor, to cause the apparatus at least to create at least one data structure that is assigned to at least one subscriber aspect, and store the at least one data structure. The at least one data structure is used as a condition for evaluating a filter criteria.

Another embodiment may include a computer program, embodied on a computer readable medium. The computer program may be configured to control a processor to perform a process including creating, in an internet protocol multimedia subsystem (IMS) based network, at least one data structure that is assigned to at least one subscriber aspect. The process further includes storing the at least one data structure in a network node of the IMS based network, and using the at least one data structure as a condition for evaluating filter criteria.

### BRIEF DESCRIPTION OF THE DRAWINGS

For proper understanding of the invention, reference should be made to the accompanying drawings, wherein:

FIG. 1a illustrates an example of a system for data storage and processing in the AS and S-CSCF;

FIG. 1b illustrates an example of a system according to an embodiment of the invention;

FIG. 2 illustrates a system according to one embodiment;

FIG. 3 illustrates a system according to another embodiment;

FIG. 4 illustrates the relation between the standardized iFC and the components of an IF-THEN-logic to be applied on different message types of SIP requests and responses;

FIG. 5 illustrates an apparatus according to one embodiment; and

FIG. 6 illustrates a flow diagram of a method according to one embodiment.

### DETAILED DESCRIPTION

It will be readily understood that the components of the invention, as generally described and illustrated in the figures herein, may be arranged and designed in a wide variety of different configurations. Thus, the following detailed description of the embodiments of a system, a method, an apparatus, and a computer program product for configurable services in IMS as represented in the attached figures, is not intended to limit the scope of the invention, but is merely representative of selected embodiments of the invention.

If desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof

Embodiments of the invention may be used in conjunction with IMS networks. As discussed above, IMS networks are built according to 3GPP standardized architecture. The SIP protocol (as defined by IETF RFC3261) is used for session handling in the IMS. The subscriber specific user profile is stored in the home subscriber server (HSS), which is the central subscriber database in the IMS network.

At the time of a subscriber registering to the IMS network, the user profile is downloaded to the serving call state control function (S-CSCF), where the profile is stored during the registration procedure. A part of this profile is a list of initial filter criteria (iFC). The iFC contain information about application servers (AS) to be involved in the signaling path for sessions and/or standalone requests. These AS will be involved in SIP message forwarding via the ISC interface. The conditions for the AS to be invoked (e.g., based on message content) are referred to as the filter rules.

Services that provide additional value to subscribers, or SIP call or SIP message adaptations and manipulations (in order to adapt services to individual network needs), are usually provided by adding AS into the signaling path. One issue that arises is how to introduce simple services, which add as little network traffic as possible, are easily adaptable by the operator itself without the need to place service implementation requests to the IMS network vendor or AS vendor, and integrate in the existing and standardized service structure of IMS networks at the S-CSCF and HSS.

As suggested above, in order to perform even simple services or to perform more enhanced service triggering, AS are introduced in the signaling path. These AS are mostly freely programmable, such as SIP servlet (JSR289) environments. The introduction of an AS network element may become a burden for the operator resulting in additional investment and operation overhead. The additional network element added to the signaling path also introduces latency and requires network resources that may cause performance degradation. In addition, the AS may need to have registration information, which must be retrieved from HSS (via Sh-interface) or from S-CSCF (via 3rd party registration), both adding additional network load and load to the consulted network nodes. Embodiments of the invention help to overcome these and other problems associated with introducing services in IMS-based networks.

According to one embodiment of the invention, data structures in the form of variables of any data-type, such as Boolean, String, or Integers, are assigned to certain subscriber aspects, such as private identity or public identity. The data structures may then be stored in the S-CSCF. In an embodiment, the variables (i.e., names and types) can freely be chosen as part of its configuration. According to certain embodiments, the data can be set, re-set, and manipulated in any way within the S-CSCF upon a matching filter criteria. In one embodiment, the data is input again as a condition for the evaluation of filter criteria in the S-CSCF.

In one example embodiment, an operator can use, for instance, SIP messages such as INVITE, according to defined iFC as a trigger to create and set any data variables assigned and stored for the involved subscriber. At any later time during the registration period, the same data variable can be evaluated within another iFC-set in order to determine the triggering of any other AS or even the manipulation of the same or other data variables. In this way, the operator can easily create simple services per configuration in the IMS network.

In this manner, the dynamic triggering logic of external AS or the creation of small services done by this data processing is completely up to the operator per configuration. As a result, the operator is free to try certain features without the need to loop a feature request via the IMS vendor.

The S-CSCF can build on standardized iFC definitions and does not need additional alignment in HSS or external AS. Also, embodiments of the invention do not result in additional network traffic degrading the overall performance due to additional data computation and dynamic service triggering in the S-CSCF. In other words, embodiments reduce the network load and computation responsibilities of the network nodes, resulting in improved network performance.

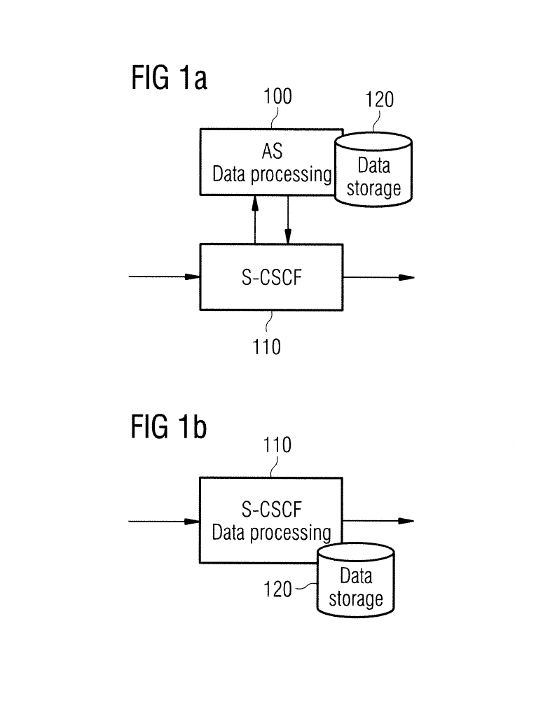

FIG. 1a illustrates an example of a system for data storage and processing in the AS and S-CSCF. According to the example of FIG. 1a, an AS 100 is included in the signalling path of the S-CSCF 110. FIG. 1b illustrates another example of a system for data storage and processing in the AS and S-CSCF, according to one embodiment. As illustrated in FIG. 1b, in this embodiment, instead of including the AS 100 in the signalling path, the S-CSCF 110 uses data structures and modifies them based on incoming events and automatic timeouts. The data structures may be stored in data storage 120.

As a result of certain embodiments, AS triggering can be performed in a more complex and dynamic manner. Even small services can be created more simply and quickly, than would be possible by involving an additional AS alone. According to certain embodiments, the handled data can include variables of any data type.

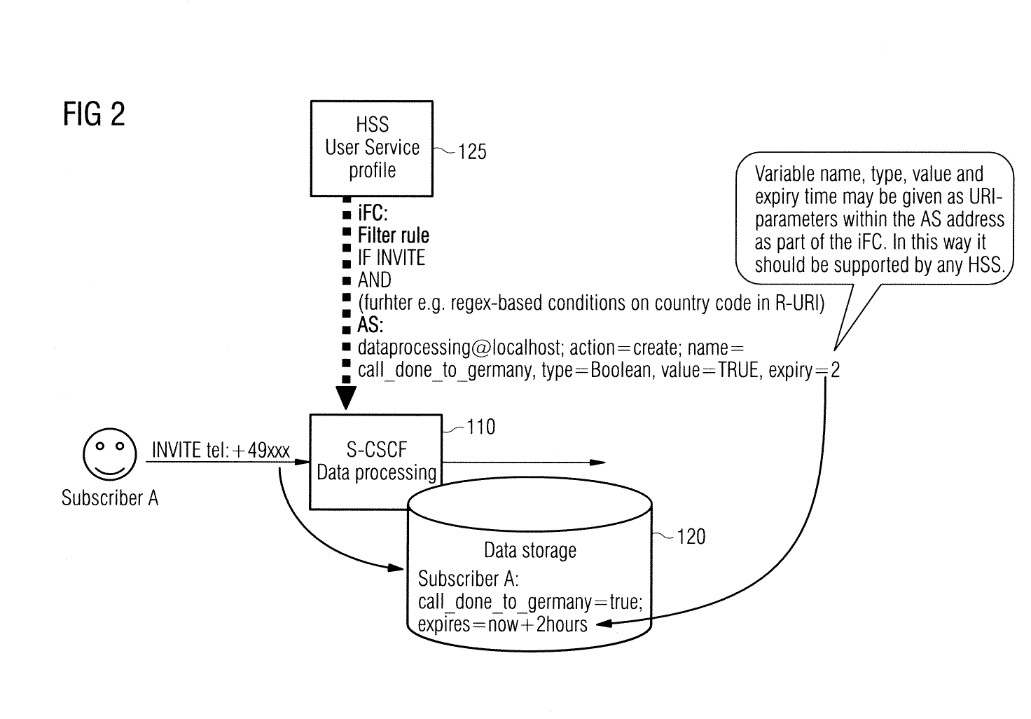

For example, FIG. 2 illustrates a system for creating and setting a variable upon SIP message trigger, according to one embodiment. As illustrated in FIG. 2, according to one embodiment, the instance of a variable can be created at the HSS 125, as well as modified and deleted based on simple iFC configurations. In this embodiment, the variable name, type, value and expiry time may be given as uniform resource identifier (URI) parameters within the AS address as part of the iFC. In this way, it should be supported by an HSS. According to the example illustrated in FIG. 2, the variable name is “call_done_to_germany,” the variable type is Boolean, the value is “true,” and the expiry time is set to 2.

The definition of iFCs may be based on 3GPP and its provisioning is already supported by any IMS based network. The filter rules of the iFC define the granularity in which situations and use cases can be distinguished.

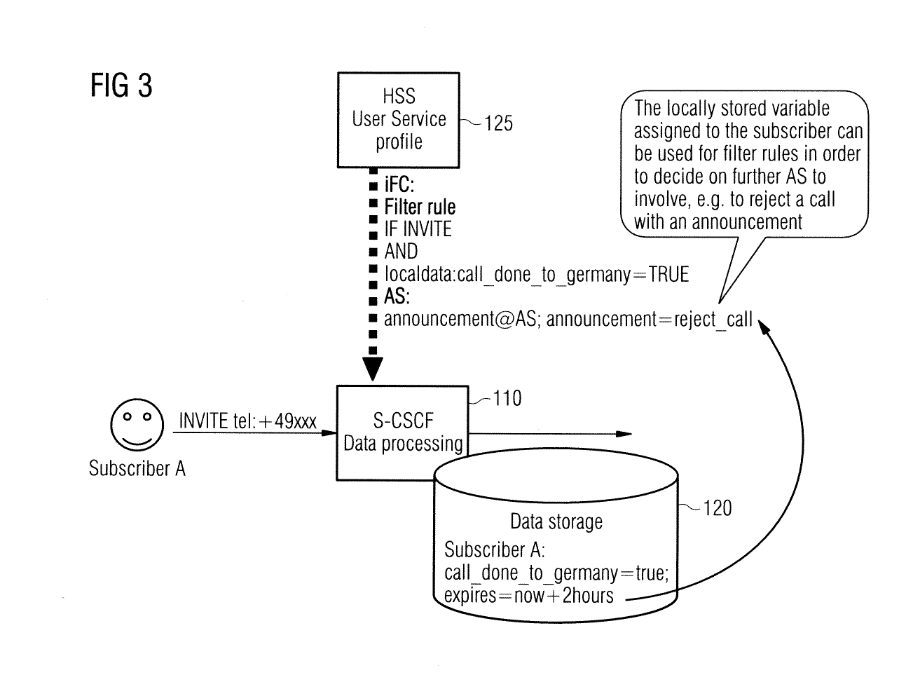

According to one embodiment, the data, which may be stored within the data storage 120 of the S-CSCF 110 and assigned to a specific subscriber, can be evaluated within the iFC as part of the filter rules. For instance, FIG. 3 illustrates a system, which includes the HSS 125 and S-CSCF 110, configured to evaluate internal data for AS triggering or further call processing according to one embodiment. As illustrated in FIG. 3, the locally assigned variable (call_done_to_germany=true) assigned to the subscriber A can be used in filter rules in order to decide on a further AS to involve. In the example of FIG. 3, when the filter rule is true, an AS is involved to reject a call with an announcement as shown by “announcement@AS; announcement=reject_call”. It should be noted that the INVITE illustrated in FIG. 3 is not the same INVITE as illustrated in FIG. 2 discussed above. Therefore, the INVITE shown in FIG. 3 is not another iFC applied to the same SIP request in order to decide on conditional second or third AS for the same INVITE. Rather, the INVITE of FIG. 3 is another INVITE that may occur at some later point in time, and whether the stored data “call_done_to_germany” is still relevant or not may depend on the expiry value set in FIG. 2 or on any other condition leading to resetting this indication. The stored data/indication may have their effect in some later session.

As a result of certain embodiments, an operator is free to configure the creation, modification, deletion or timer-based expiry of freely named variables of any supported data type. In one embodiment, as discussed above in connection with FIGS. 2 and 3, this is done by placing the conditions in the filter rules of an iFC and the action in the AS-address, which points to a local implementation to the S-CSCF to perform the intended data modification. The data can be of any supported data type (e.g., Boolean, String, Integer) and the data modification can be any supported processing of the respective types, e.g., incrementing, decrementing, adding or deleting.

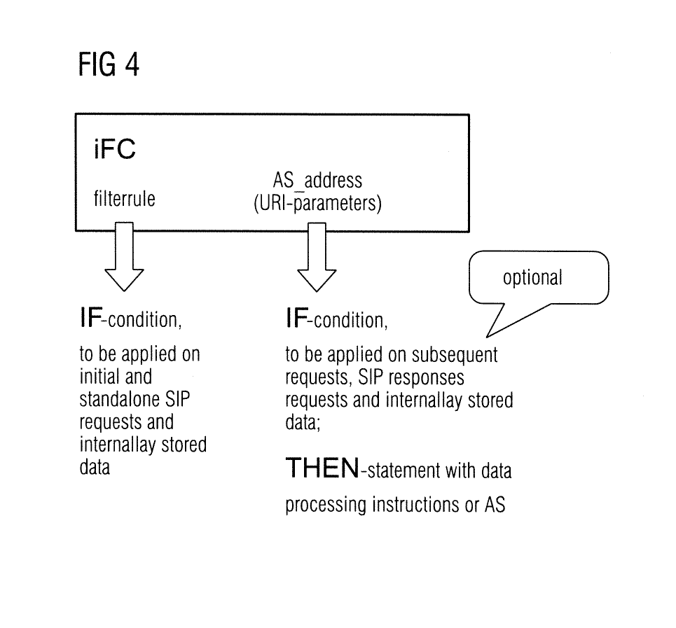

Resulting from that, an IF-THEN statement can be formed by describing the IF-part in the filter rules and the THEN-part in the AS-address of the iFC. Following the nature of iFCs, the trigger for its evaluation is any session-initiating or standalone SIP request received in the S-CSCF. For the IF-condition, the filter rules can also evaluate previously set local data, i.e., the stored variables. According to certain embodiments, for one SIP-message a multiple number of iFCs (IF-THEN-statements) can be processed. As the iFCs are evaluated only at the processing of session-initiating SIP requests, the data processing can be triggered at this point, but the THEN-statement (i.e., the AS-address aiming at the internal data processing) can contain further conditions to be applied on the existence and content of subsequent SIP requests or SIP responses. FIG. 4 illustrates the relation between the standardized iFC 400 and the components of an IF-THEN-logic 410 to be applied on different message types of SIP requests and responses.

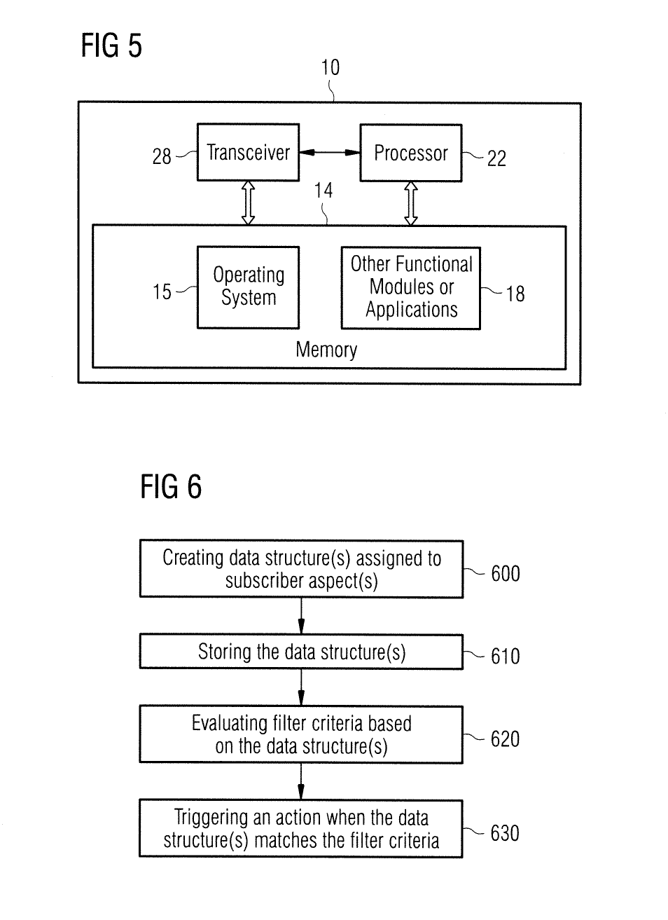

FIG. 5 illustrates an apparatus 10 according to another embodiment. In an embodiment, apparatus 10 may be a network node in an IMS based network, such as a S-CSCF or HSS. It should be noted that one of ordinary skill in the art would understand that apparatus 10 may include components or features not shown in FIG. 5. Only those components or feature necessary for illustration of the invention are depicted in FIG. 5.

As illustrated in FIG. 5, apparatus 10 includes a processor 22 for processing information and executing instructions or operations. Processor 22 may be any type of general or specific purpose processor. While a single processor 22 is shown in FIG. 5, multiple processors may be utilized according to other embodiments. In fact, processor 22 may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as examples.

Apparatus 10 further includes a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (“RAM”), read only memory (“ROM”), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas (not shown) for transmitting and receiving signals and/or data to and from apparatus 10. Apparatus 10 may further include a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

As mentioned above, in some embodiments, may be a network node in an IMS based network, such as a S-CSCF or HSS. According to one embodiment, apparatus 10 may be controlled by memory 14 and processor 22 to create one or more data structures that are assigned to one or more subscriber aspects. For example, the subscriber aspects may be private identity or public identity. The one or more data structures may include one or more variables with a name and type that can be customized as part of the configuration of the data structure(s). As an example, the data type of the variable(s) may include Boolean, string, or integer.

In an embodiment, apparatus 10 may be controlled by memory 14 and processor 22 to store the one or more data structures in a network node of the IMS based network. For instance, the network node in which the data structure(s) are stored may be a S-CSCF. In some embodiments, the data structure(s) can be used as a condition for evaluating filter criteria. According to one embodiment, the filter criteria are an iFC. An instance of the variable(s) can be created, modified, or deleted based on the iFC configurations.

According to certain embodiments, when the data structure matches the filter criteria, an action is triggered within the network node. For example, the action may include modifying the data structure within the network node by incrementing, decrementing, adding or deleting the data structure. In other words, embodiments of the invention may change the data structure the iFCs are using. For instance, in the example discussed above, the stored data “call_done_to_germany” is set or reset, but the filter rule in the iFC “localdata:call_done_to_germany=TRUE” is not changed due to the described procedure. In some embodiments, a trigger for evaluating the condition includes any session initiating or SIP request received in the network node (e.g., S-CSCF).

FIG. 6 illustrates a flow diagram of a method for providing configurable services in an IMS based network based on standardized iFC, according to one embodiment. The method includes, at 600, creating one or more data structures that are assigned to one or more subscriber aspects, such as private identity or public identity. The data structure(s) may include one or more variables, and the name and type of the variables can be customized as part of the configuration of the data structure(s). The method may then include, at 610, storing the data structure(s) in a network node of the IMS based network, such as a S-CSCF. The method may further include, at 620, evaluating filter criteria based on the data structure. In other words, the data structure(s) can be used as a condition for evaluating the filter criteria. In some embodiments, the method may also include, at 630, triggering an action when the data structure(s) fulfills or matches the filter criteria. According to one embodiment, the action triggered may also be an adaptation/manipulation of the stored data structures.

According to certain embodiments, the functionality of the flow diagram of FIG. 6, or that of any other method described herein, may be implemented by software stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

The computer readable media mentioned above may be at least partially embodied by a transmission line, a compact disk, digital-video disk, a magnetic disk, holographic disk or tape, flash memory, magnetoresistive memory, integrated circuits, or any other digital processing apparatus memory device.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

We claim:

1. A method, comprising:
creating, in an internet protocol multimedia subsystem (IMS) based network, at least one data structure that is assigned to at least one subscriber aspect;
storing the at least one data structure in a network node of the IMS based network; and
using the at least one data structure as a condition for evaluating filter criteria.

2. The method according to claim 1, wherein, when the at least one data structure matches the filter criteria, an action is triggered.

3. The method according to claim 1, wherein the action comprises modifying the at least one data structure within the network node by incrementing, decrementing, adding or deleting the at least one data structure.

4. The method according to claim 1, wherein a trigger for the evaluating of the filter criteria comprises receiving any session initiating or standalone session initiation protocol (SIP) request in the network node.

5. The method according to claim 1, wherein the at least one data structure comprises at least one variable with a name, data type, and expiry time that are customized as part of a configuration of the at least one data structure.

6. The method according to claim 5, wherein the data type of the at least one variable comprises at least one of Boolean, string, or integer.

7. The method according to claim 5, wherein an instance of the at least one variable is created, modified, or deleted based on configurations of the filter criteria.

8. The method according to claim 1, wherein the at least one subscriber aspect comprises private identity or public identity.

9. The method according to claim 1, wherein the network node comprises a serving call state control function (S-CSCF).

10. The method according to claim 1, wherein the filter criteria comprises an initial filter criteria (iFC).

11. The method according to claim 5, wherein the at least one data structure is set or reset when the expiry time is reached.

12. An apparatus, comprising:
at least one processor; and
at least one memory including computer program code,
the at least one memory and the computer program code configured, with the at least one processor, to cause the apparatus at least to
create at least one data structure that is assigned to at least one subscriber aspect;
store the at least one data structure,
wherein the at least one data structure is used as a condition for evaluating a filter criteria.

13. The apparatus according to claim 12, wherein the at least one memory and the computer program code are further configured, with the at least one processor, to cause the apparatus at least to trigger an action when the at least one data structure matches the filter criteria.

14. The apparatus according to claim 13, wherein the action comprises modifying the at least one data structure within the network node by incrementing, decrementing, adding or deleting the at least one data structure.

15. The apparatus according to claim 12, wherein the at least one memory and the computer program code are further configured, with the at least one processor, to cause the apparatus at least to receive a session initiating or standalone session initiation protocol (SIP) request to trigger the evaluating of the filter criteria.

16. The apparatus according to claim 12, wherein the at least one data structure comprises at least one variable with a name, data type, and expiry time that are customized as part of a configuration of the at least one data structure.

17. The apparatus according to claim 16, wherein the data type of the at least one variable comprises at least one of Boolean, string, or integer.

18. The apparatus according to claim 16, wherein an instance of the at least one variable is created, modified, or deleted based on configurations of the filter criteria.

19. The apparatus according to claim 12, wherein the at least one subscriber aspect comprises private identity or public identity.

20. The apparatus according to claim 12, wherein the apparatus comprises a serving call state control function (S-CSCF).

21. The apparatus according to claim 12, wherein the filter criteria comprises an initial filter criteria (iFC).

22. The apparatus according to claim 16, wherein the at least one data structure is set or reset when the expiry time is reached.

23. A computer program, embodied on a computer readable medium, the computer program configured to control a processor to perform a process, comprising:
creating, in an internet protocol multimedia subsystem (IMS) based network, at least one data structure that is assigned to at least one subscriber aspect;
storing the at least one data structure in a network node of the IMS based network; and
using the at least one data structure as a condition for evaluating filter criteria.
